(19) United States
(12) Patent Application Publication
(10) Pub. No.: US 2003/0054829 A1
(43) Pub. Date: Mar. 20, 2003

(54) Channel allocation method in a cellular radio network

(76) Inventor: Martti Moisio, Espoo (FI)

Correspondence Address: PILLSBURY WINTHROP, LLP, P.O. BOX 10500, MCLEAN, VA, 22102, US

(21) Appl. No.: 10/171,380

(22) Filed: Jun. 14, 2002

Related U.S. Application Data
(63) Continuation of application No. PCT/FI00/01095, filed on Dec. 14, 2000.

(30) Foreign Application Priority Data
Dec. 15, 1999 (FI) 19992695

(51) Int. Cl. H04B 17/00; H04Q 7/20; H04B 7/00

(52) U.S. Cl. 455/452; 455/509; 455/512; 455/513; 455/67.1

(57) ABSTRACT

A cellular radio system comprising at least one base station and at least one terminal communicating over a radio connection with a base station and a controller for carrying out dynamic channel allocation in a cellular radio network. The controller included in the cellular radio system is arranged to group said one or more terminals communicating over a radio connection with the base station of the cellular radio system into one or more terminal groups, and the controller is arranged to form a priority list for each terminal group of the radio channels in the cellular radio network from the highest quality channels as regards the terminal group, and to allocate one or more radio channels from the channels on the priority list to the terminal if need be.

### FIELD OF THE INVENTION

This application is a Continuation of International Application PCT/FI00/01095 filed Dec. 14, 2000, which designated the U.S. and was published under PCT Article 21(2) in English.

The invention relates to a method and an apparatus implementing the method for carrying out dynamic channel allocation in a cellular radio network.

### BACKGROUND OF THE INVENTION

In cellular radio networks data transmission resources administered by a network, for example an operator, are used for establishing a connection between terminals. In a radio interface the data transmission resources refer to a frequency band between a terminal, such as a mobile phone, and a base station. The frequency band available can be divided into physical data transmission resources i.e. channels in various ways, the most common thereof being Time Division Multiple Access (TDMA) and Code Division Multiple Access (CDMA). In systems based on TDMA the frequencies on the frequency band are divided into time slots, each one of which forms a channel when being periodically repeated. Then again, in systems based on CDMA all users communicate on the same frequency band that allows the users to be distinguished from one another using one or more spreading codes allocated for the connection.

The data transmission resources available to a single operator are in practice very limited regarding the number of users, and consequently the use of the available frequency band must be optimised reusing the frequencies in the network. This becomes possible, as the radio range of the base stations at a frequency only extends a certain distance, whereby the same frequency and the same channel can be reused in the network without causing excessive interference. In addition to reusing the same channels, the variety of the terrain and the use of the channel's adjacent channels cause interference to the channels. In the CDMA systems all connections use the same frequency, in which case the connections cause some interference to each other. The use of conceivably different spreading codes can minimize the interference.

The interference the mobile stations cause to one another can be eliminated in various ways in mobile systems. One significant way to reduce interference is network planning, which allows the available resources, such as radio channels, to be divided into base stations so as to minimize the interference the terminals communicating therein cause one another. The channel allocation between terminals distinguishes two principally opposing methods; the channels can either be fixedly divided between cells or alternatively the channels can be dynamically divided without exactly determining the available channels for the cells. Channel allocation can also be carried out using a hybrid method of the fixed and dynamic allocation.

Fixed Channel Allocation (FCA) is based on the fact that the available channels are permanently divided to cells on the basis of the predetermined traffic load of the cells. The method is particularly applicable to cellular radio systems composed of macro cells, in which systems the amount of traffic is relatively stable. To fixedly connect channels to cells is not preferable in cellular radio systems in which the traffic amount varies extensively, since the connection establishments occurring within the cell range may encounter congestion, even if the adjacent cells would have free data transmission resources available. The channel's borrowing methods allow to freely borrow channels from the neighbouring cells if the borrowed channel does not interfere with the ongoing connections. Access right to the borrowed channel is then prevented from several other neighbouring cells. In micro cell environments the allocation of data transmission resources frequently employs Dynamic Channel Allocation (DCA), in which case the channels and the cells are not fixedly dependent on one another. Any cell can use any channel as far as the interference levels of the channel remain within the allowed limits. The dynamic channel allocation is justified in a network with a small cell size, since a need for several cell changes may occur during the connections. In urban environments that often use micro cell networks the temporal and local fluctuations in traffic amounts can be very significant, and a temporary need for resources in any area may become extensive.

The DECT system, for example, employs a Minimum Interference (MI) method for channel allocation, where the base station searches an unused channel, which is mostly free from interference, for the terminal. The minimum interference method functions fairly well for homogeneous communication such as speech, whereby the interference caused to the neighbouring channels by the channel allocated for speech remains substantially equal. Bursty data traffic is in this respect more problematic, since the interference is extensive to the neighbouring connections when data is sent, whereas no interference is caused during quiet moments. FIG. 2A shows two terminals 202A and 202B, which are within the coverage area of a base station 200. Bursty data 204 travels between the terminal 202A and the base station 200. In the situation shown in FIG. 2A, the terminal 202B does not encounter interference from the channel at the time indicated by the arrow, when the terminal 202B listens to the terminal 202A communicating on the adjacent channel. In such a case, the terminal may reach disadvantageous conclusions when searching for the most interference-free channel, as a connection allocated for data traffic may temporarily be in such a mode, in which data does not move and interference is therefore not caused to the neighbouring connections.

Conventional channel allocation methods are also poorly applicable to the asymmetric traffic, particularly in systems using Time Division Duplex (TDD), i.e. the uplink and downlink directions are implemented on the same frequency band, for example, so that some of the time slots are allocated to the uplink traffic and others to the downlink traffic. FIG. 1 illustrates the above situation. On a frame 100A shown at frequency f1, four time slots are allocated to the uplink direction X1 to X4 and four time slots Y1 to Y4 to the downlink direction. On a frame 100B shown at frequency f2, two time slots are allocated to the uplink direction X1 to X2 and six time slots Y1 to Y6 to the downlink direction. The Figure shows that for example the transmission on the uplink direction at frequency f1 in accordance with a time slot 102A is carried out simultaneously as the transmission of the downlink direction 102C at frequency f2. The above situation may occur, for example, when a user temporarily requiring a lot of data transmission capacity in the downlink direction operates at frequency f2. The situation illustrated in FIG. 1 causes significant interference, when the terminals are located close to each other, for example, in a base station receiving the uplink transmission at frequency f1.

### BRIEF DESCRIPTION OF THE INVENTION

It is an object of the present invention to provide an improved method and an apparatus for channel allocation in a cellular radio network so as to solve the above problems. This is achieved with the method of the invention for implementing dynamic channel allocation in a cellular radio network. This method comprises the steps of grouping the terminals communicating over a radio connection with the base station of the cellular radio network into one or more terminal groups and forming a priority list for each terminal group of the radio channels in the cellular radio network from the highest quality channels as regards the terminal group, and allocating one or more radio channels from the channels on the priority list to the terminal if need be.

The invention also relates to a cellular radio system comprising at least one base station and at least one terminal communicating over a radio connection with the base station and a controller for carrying out dynamic channel allocation in a cellular radio network. The controller included in the cellular radio system is arranged to group said one or more terminals communicating over a radio connection with the base station of the cellular radio system into one or more terminal groups, and the controller is arranged to form a priority list for each terminal group of the radio channels in the cellular radio network from the highest quality channels as regards the terminal group, and to allocate one or more radio channels from the channels on the priority list to the terminal if need be.

The preferred embodiments of the invention are disclosed in the independent claims.

The invention relates to a method and an apparatus implementing the method for carrying out dynamic channel allocation in a radio network. The radio network preferably refers to a mobile network, which allows the radio channels to be dynamically allocated to the terminals. The invention can be applied to digital mobile networks without being restricted to a multiple access method of the mobile network, for example. The invention is preferably applicable to a mobile network using time division duplex TDD, but the invention is not restricted thereto and is applicable to other radio networks as well, which use frequency division duplex FDD. The terminal is preferably a mobile phone but can be any apparatus comprising a radio transmitter and a receiver and located in the coverage area of the radio network. Examples of such apparatuses are computers, household appliances and the like.

In accordance with an embodiment of the invention, the terminals located within the range of the radio network base station are divided into groups according to some criteria, for example on the basis of the distance from the terminal base station. Grouping can be carried out more specifically in accordance with the location information, in which case the terminals located in the same range are preferably grouped into the same group. The grouping is based on the fact that the interference encountered by the terminals located close to one another on different radio channels are near one another. The terminal groups may vary in size, and the smallest groups comprise only one terminal and the largest groups comprise all the terminals in a particular coverage area. A particular number of channels divided into priority and candidate channels is thus allocated for each terminal group formed from the channel space available to the base station. Candidate channels, or standby channels, can be used, for example, in situations, where the terminals require more radio channel capacity. A standby channel can also be taken into use, when the channel on the priority list encounters significant interference from the surrounding channels, and the use thereof is stopped. The transfer of channels between the priority list and the standby list is made slow, in which case the interference experienced by the terminal group remains stable.

In accordance with an embodiment of the invention, a priority list is formed of radio channels, which are to be allocated for each terminal group, to both uplink and downlink directions. The radio channels are preferably arranged in order of superiority on the priority list on the basis of the priority value. The priority value is increased if the terminal reports that the channel is of good quality, whereas the priority value is reduced if the terminal reports that the channel is of poor quality. The good quality of the channel can be solved for example by setting threshold values to the variables, such as the Negative ACKnowledgement (NACK) of the packets, the Cyclic Redundancy Check (CRC) or the Signal-to-Interference ratio (SIR). The channels on the priority list are therefore preferably arranged in order of superiority according to the measurement results regarding the use of the channels. Furthermore, according to a preferred embodiment the channels are arranged in order of superiority so that the uplink channels are arranged in accordance with the measurements performed by the base station, and the downlink channels are arranged in order of superiority in accordance with the measurements performed by the terminal. When the terminal establishes a data transmission connection through the cellular radio network, one or more of the best channels on the priority list of said terminal group is allocated to the terminal in accordance with a preferred embodiment. A Quality of Service criterion can also be used in allocation, whereby a channel corresponding to the QoS classification is allocated to the terminal. A user paying significantly for his connections could in such a case obtain better channels than a user paying less for his connections.

According to a preferred embodiment of the invention, candidate lists are maintained for each terminal group in the uplink and downlink directions for the above priority lists. The candidate list includes in order of superiority channels that provide, if necessary, a supplement for the priority list channels. The channels on the candidate list can also replace such priority list channels, whose quality level, or priority value, decreases below a predetermined threshold value. According to a preferred embodiment of the invention the channels on the candidate list are arranged in order of superiority on the basis of signal strength measurements, or reception power measurements, performed in the available time slots. In such a case, interference strength is measured, for example, from channels adjacent to an available time slot. The uplink measurements are carried out in the base station, whereas the downlink measurements are carried out in the terminal. The terminals signal the measurement results to the base station, where the priority and candidate lists are maintained in a preferred embodiment of the invention. The invention is not restricted to maintaining said lists in the base station, but the lists can also be implemented in, for example, the base station controller or in another corresponding cellular radio network part. Preferably the base station controls the measurements of the terminals in a particular terminal group so as to maximize the number of measurements performed by the terminal group. The base station thus co-ordinates for instance the fact that two terminals belonging to a particular terminal group do not simultaneously measure the same channel.

The solution of the invention provides several advantages. Since the set of channels allocated to be used by the groups is stable owing to an insignificant amount of variation between the priority list and the candidate list, the solution is well suitable for transmitting traffic in packet form. Then the interference measurements to be performed for different channels are carried out in the long run, and the temporarily quiet interference channels are not easily allocated for use.

The solution of the invention also allows to properly allocate temporarily greater bandwidths for asymmetrical connections in cellular radio networks using time division duplex (TDD). In general, the problem with asymmetrical connections is that a time slot allocated in the uplink direction of a frequency can be a time slot allocated to the downlink direction of an adjacent frequency. The solution of the invention allows the channels suffering from asymmetry to obtain poor measuring reports during use and to rapidly transfer them from the priority list.

### BRIEF DESCRIPTION OF THE DRAWINGS

In the following the invention will be described in greater detail by means of the preferred embodiments with reference to the attached drawings, in which

FIG. 1 shows how two adjacent frequencies overlap in relation to the time slots in the uplink and downlink directions,

FIG. 2A shows two terminals located in the base station area, one of the terminals communicates in the direction of the base station using bursty data traffic,

FIG. 2B shows a mobile network,

FIGS. 3A-3C are a flow chart showing a method of the invention,

FIG. 4 schematically shows the channel division of the invention,

FIG. 5 shows how the terminals are grouped on the basis of propagation losses, and

FIG. 6 shows a preferable embodiment of an apparatus arrangement of the invention.

### DETAILED DESCRIPTION OF THE INVENTION

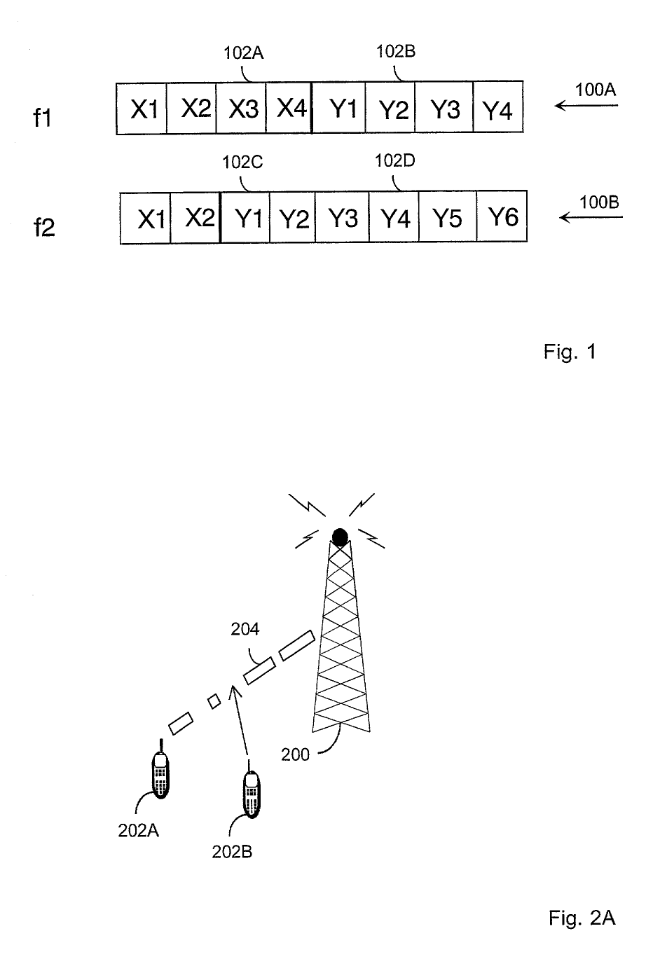

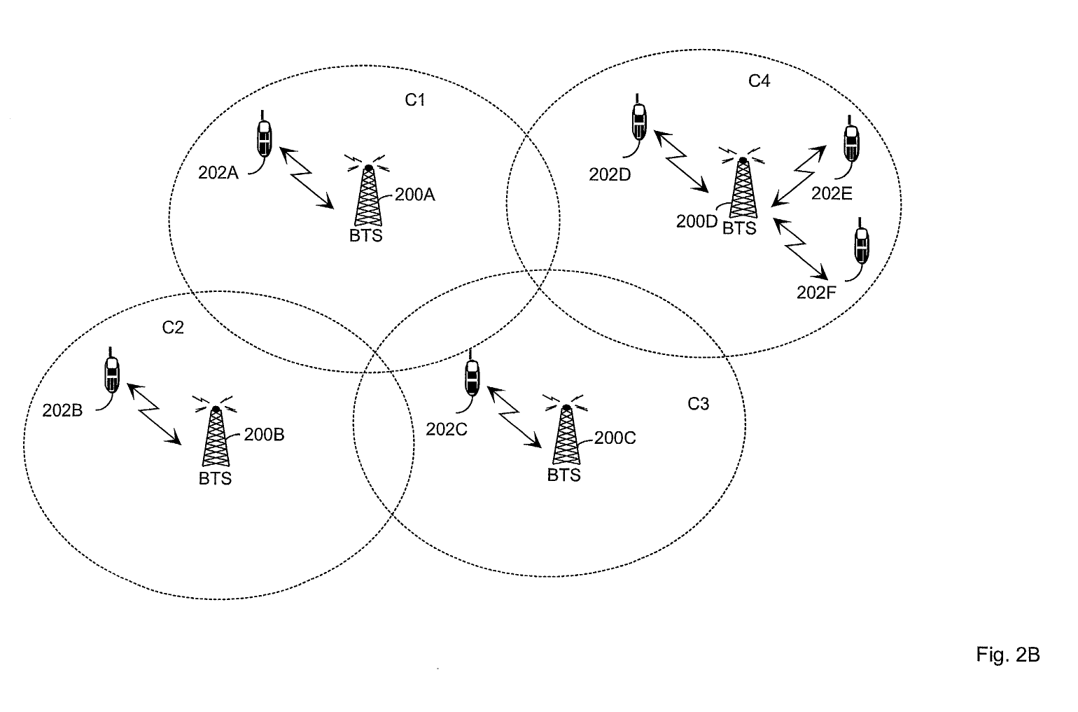

In the following the invention will be described in greater detail with reference to the appended FIGS. 1 to 9, and in the specification by means of a cellular radio network employing mainly CDMA, however, without being restricted thereto. FIG. 2B is a broad description of a mobile system comprising base stations 200A to 200D. The coverage area of the base station is referred to as a cell indicated by C1 to C4 in the Figure and corresponding to base station 200A to 200D. The cells may overlap and extend over each other; cell C2 partly overlaps cells C1 and C3 in the Figure. One or more mobile stations 202A to 202F are described in the Figure within the area of each cell C1 to C4. The mobile stations are, for example, mobile phones but can also be other apparatuses, such as computers, household appliances or the like provided with radio receiver and/or transmitter properties. In a radio network employing a code division multiple access method, such as a mobile network, all users employ the same frequency band simultaneously. Several practical applications, also adjacent cells like the cells C1 to C4 presented in FIG. 2B, employ the same frequency band.

The information sent to the radio channel is multiplied by a spreading code, thus spreading relatively narrowband information over a broad frequency band. Each connection is provided with a specific spreading code or spreading codes enabling the receiver to identify transmissions intended thereto. The spreading codes of the users tend to be orthogonally selected, and thus avoiding correlation with one another. In practice, the spreading codes are not completely orthogonal with each other, and therefore the users interfere with one another. In FIG. 2B, the receivers 202D to 202F interfere with one another and experience interference from the terminals 202A to 202C located within the area of the other cells C1 to C3. Interference is also created between the terminals 202A to 202F, when a signal sent by each terminal propagates along various paths to the receiver. This, so-called multi-path propagation leads to the fact that the user signal arrives at the receiver as a component delayed in various ways, thus causing interference to other users.

The information transmitted between the base stations 200A to 200D and the terminals 202A to 202F is carried out using a bi-directional radio connection by means of radio channels. The uplink direction refers to the information flow directed from the terminal to the base station, whereas the downlink direction refers to a transmission directed from the base station to the terminal. The uplink and downlink directions can be distinguished in the CDMA, for example, using Frequency Division Duplex (FDD), in which case the uplink and downlink directions are in different frequency areas, or using Time Division Duplex (TDD), in which case the transmission directions are temporally distinguished from one another. For example, the FDD mode of UMTS employs the following channels: A DCH is used both for the uplink and downlink directions for conveying user and control information between the base stations 200A to 200D and the terminals 202A to 202F. A BCH (Broadcast Channel) is used in the downlink direction for conveying information to the terminals from the cell and a PCH (Paging Channel) is used for requesting location data from the terminal, when the system does not know the location of the terminal. A FACH (Forward Access Channel) is used for transmitting information to the terminal, when the base station knows the location of the terminal and a RACH (Random Access Channel) can be used in order for the terminal to convey control information in the uplink direction for example to establish a connection, and a SCH (Synchronization Channel) can be employed in order for the system to convey synchronization information to the terminal. A Downlink Shared Channel (DSCH) is particularly suitable for conveying data traffic. Said channel can be used for sending control and trafficking information intended for several terminals. Some radio channels have been presented above by way of example, and as to the invention the presentation of all channels is not relevant in this context. The transmission on the radio channels is carried out in bursts of a specified form including for example pilot symbols, user data and control information. The pilot symbols are frequently placed in the middle of the burst, thus describing to best possible effect the distortions caused by the radio channel to the entire user data in the burst. The pilot symbols are a set of symbols known by both the terminals 202A to 202F and the base stations 200A to 200D. Based on the pilot symbols, the party receiving the burst, forms an impulse response of the channel in order to clarify the strengths and delays of the multi-path propagated components. On the basis of the impulse response a finger branch is allocated for the best signal components in the receiver, for example in a RAKE receiver. The channel estimation information thus obtained from the pilot symbols is utilized in the receiver for interference cancellation; the information is intended to remove interference from the received user signals, in which case the information sent by the transmitter can be received as correctly as possible.

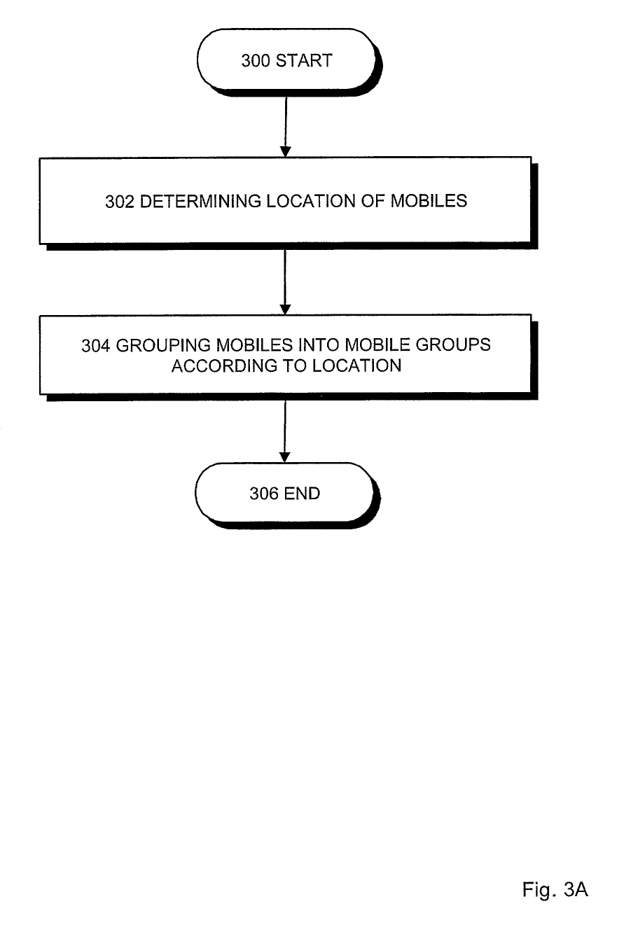

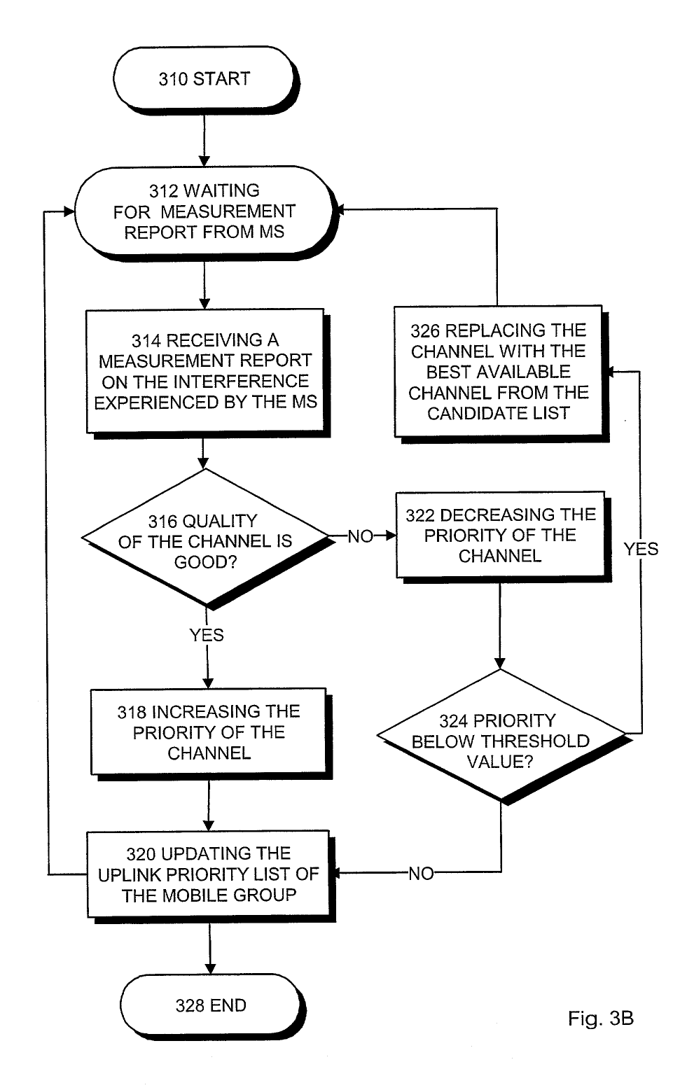

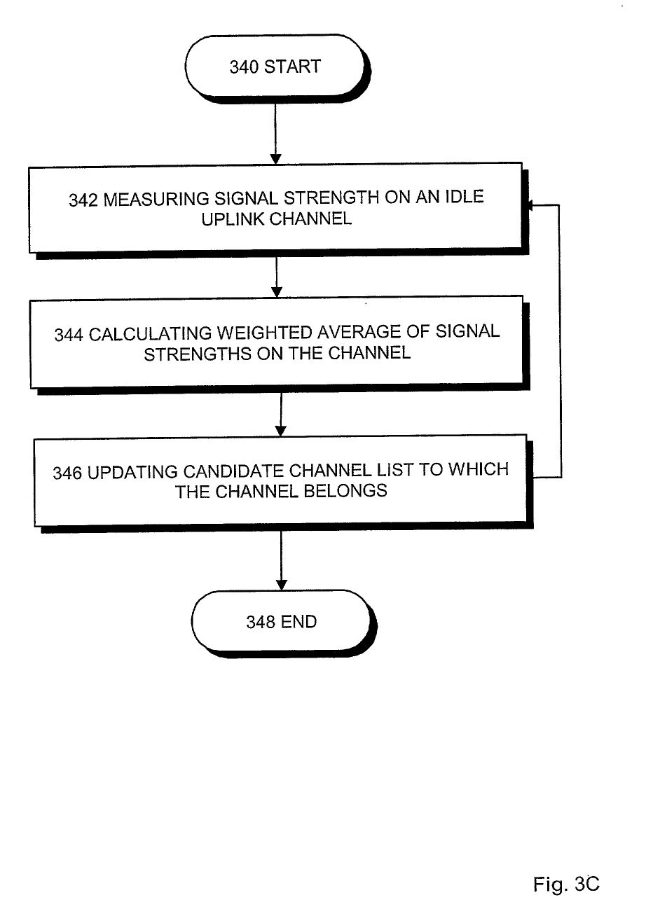

FIGS. 3A to 3C illustrate the method of the invention by means of a preferred embodiment. FIG. 3A shows how the terminals are grouped into terminal groups. In starting step 300 of the method, no terminals are placed in the coverage area of the radio network, but they start to appear to the cellular radio network area. The cellular radio network, such as a mobile network, measures the locations of the terminals within the cellular radio network area using a known method. The location is determined in the GSM system for example using a triangulation technique, in which the terminal determines the Timing Advance (TA) in relation to three different base stations. The timing advance allows to determine the distance to each base station within the accuracy of about 550 meters, corresponding to the propagation distance of light during the transmission of one single bit. The GPS (Global Positioning System) offers a more accurate location determination and enables to determine the location with the accuracy of meters or even centimeters. In such a case, the cellular radio network forms in accordance with step 304 a terminal group of the terminals within the same area, and the cellular radio network allocates a particular set of radio channels for each group. When the terminals are positioned into terminal groups according to the location thereof, a terminal arriving later at a corresponding area can be located into the same group with the other terminals in the area. As the terminal travels in the cellular radio network into the area of another terminal group, the terminal is preferably transferred into the terminal group, to which area the terminal has moved. In a preferred embodiment of the invention, there are no limitations concerning the number of terminal groups to which the terminal may belong. For example, when the terminal moves in an area corresponding to the areas of two terminal groups, the terminal may belong to both terminal groups and obtain from there channels into use.

FIG. 3B explains how an uplink priority list according to a preferred embodiment is maintained. Terminals have communicated within the mobile network in starting step 310 of the method, and therefore measurement information on the interference experienced by the terminals is available. In step 312 the base station waits for the measurement results from the terminals, which have established through the base station a connection to another terminal located within the cellular radio network area or outside the area. In order to maintain the priority list the base station preferably utilizes the measurement reports sent by the terminals concerning the interference experienced by the terminals on the connection used. In step 314 the base station receives a measurement report sent by the terminal. Several measurement reports are sent repeatedly, for example periodically, during a connection. The measurement report can be based on for example Negative ACKnowledgements (NACK) i.e. the number of data packets intended for the terminal that the terminal is likely to reject on account of transmission errors that occur during data transmission from the base station to the terminal. The terminal may report about the good quality of the connection according to the Cyclic Redundancy Check (CRC), signal-to-interference ratio or to another corresponding criterion.

In step 316 the quality of the connection used is evaluated and if the terminal reports that the connection is good, for example exceeds a particular threshold value, the base station increases in step 318 the priority of said channel in accordance with formula (1), where P depicts the channel priority and N the number of measurements. P can obtain values ranging between 0 and 1 and 1 can be used as the initial value.

$${P}_{i + 1} = \frac{{P}_{i} \times {N}_{i} + 1}{{N}_{i} + 1} \qquad ( 1 )$$

N describing the number of measurements is increased in accordance with formula (2). Preferably an upper limit or a certain time limit is determined for N, in which case it is zeroed. Otherwise N may increase into such a proportion that the new measurement results do not affect the value of P.

Nᵢ₊₁=Nᵢ+1 (2)

If the terminal sends a report concerning the measured channel, according to which report the used channel is a poor quality channel, then the priority value thereof is reduced in step 322 in accordance with formula (3). In this case too, the value of N is increased in accordance with formula (2).

$${P}_{i + 1} = \frac{{P}_{i} \times {N}_{i}}{{N}_{i} + 1} \qquad ( 3 )$$

Since the priority list stores the best channels available to the terminal group, a threshold value is preferably set for the priority list channels, which is checked in step 324. If the priority value goes below the threshold value, the channel is removed from the priority list in accordance with step 326 and is preferably replaced with the best channel on the candidate list. In table 1, if the threshold value of the priority channels, the channel being removed from the priority list if it goes below the threshold value, is for example 0.40, then channel (906,6;8) is removed from the priority list as the priority value is reduced to 0.38. In such a case, the channel (906,6:8) is replaced with the best possible channel on the downlink candidate list of the terminal group of said terminal group, and channel (906,6:8) is transferred to the candidate list. How to use the candidate list is explained in greater detail in FIG. 3C.

Table 1 presents an example of the contents in a priority list of one terminal group. The table comprises a column describing the order in which value 1 depicts the best channel and an increase in the consecutive number signifies a channel decrease. The radio resource to be used is determined in column “channel”, as in table 1 the radio resource is shown using the GSM system. For example, the best channel with the consecutive number 1 is the third time slot at frequency 910.2 MHz. The column “priority” is calculated according to formula 1 or 3, and the number of measurement reports needed in formulas 1, 2 and 3 is maintained in column “index”. Column “mode” depicts the mode of the channel, i.e. whether the channel is occupied of free. In accordance with method step 320 the priority list of the terminal group is updated always when a measurement report concerning channel quality is obtained from the terminal. The priority list illustrated in table 1 shows an example of a priority list of a terminal group, but it is obvious that all terminal group priority lists can be combined so as to add a column to table 1 identifying the terminal group. The maintenance of a downlink priority list is described above. The maintenance of an uplink priority list is carried out in a preferred embodiment in the same way as described above, except that the base station performs the channel quality measurements instead of the terminal. When the terminal requires radio resources from the cellular radio network, channels are allocated from the priority list. According to a preferred embodiment the best available channel is allocated from the priority list of the terminal group of the terminal. In accordance with another preferred embodiment a QoS criterion is used in allocation, i.e. the user with a higher quality classification may employ better channels than a user with a lower quality classification.

TABLE 1
Priority list

| | Channel (frequency, | | | |
|---|---|---|---|---|
| Order | time slot) | Priority, P | Index, N | Mode |
| 1 | (910, 2; 3) | 0, 92 | 1524 | MS#2 |
| 2 | (898, 8; 6) | 0, 84 | 1035 | Idle |
| 3 | (894, 4; 4) | 0, 82 | 687 | MS#1 |
| 4 | (902, 6; 2) | 0, 77 | 3562 | Idle |
| 5 | (911, 4; 1) | 0, 72 | 4214 | Idle |
| 6 | (906, 6; 8) | 0, 38 | 269 | Idle |

FIG. 3C shows an example of how the uplink candidate list is maintained in a method step form. In starting step 340 of the method, the cellular radio network area comprises terminals grouped into terminal groups on the basis of the location of the terminals, for example. A priority list is allocated for each terminal group and comprises the best channels available to be used by the terminal group. According to a preferred embodiment, a candidate list is allocated to the priority list channels. Spare channels replacing a priority list channel if necessary are stored onto the candidate list. According to a preferred embodiment the channels on the candidate list are arranged in order of superiority based on the measurements performed in the idle mode. Here, quality refers to signal strength measurements, for example. In the uplink direction the base station performs the measurements in accordance with step 342, whereas in the downlink direction the terminals perform the measurements and signal the measurement results to the base station. The base station preferably controls the function of the terminal so that two terminals belonging to the same group do not measure the same channel. Table 2 shows an example of a candidate list of a terminal group. The column “order” illustrates the order of superiority of the channels in the same way as in the priority list, and column “channel” the physical definition of the channel. Column “quality” is preferably the weighted average to be calculated for example in method step 344 concerning the signal strengths of the measurements performed for the channel. The signal strength is preferably measured from the idle time slots, in which case a higher signal strength indicates higher interferences and therefore poorer quality. When calculating the weighted average, the most recent measurements can for example be weighted more than old measurement results. The weighting factor can then be for instance a linearly falling straight.

TABLE 2
Candidate list

| Order | Channel | Quality |
|---|---|---|
| 1 | (912, 4; 1) | 92 |
| 2 | (896, 0; 4) | 88 |
| 3 | (884, 6; 5) | 75 |

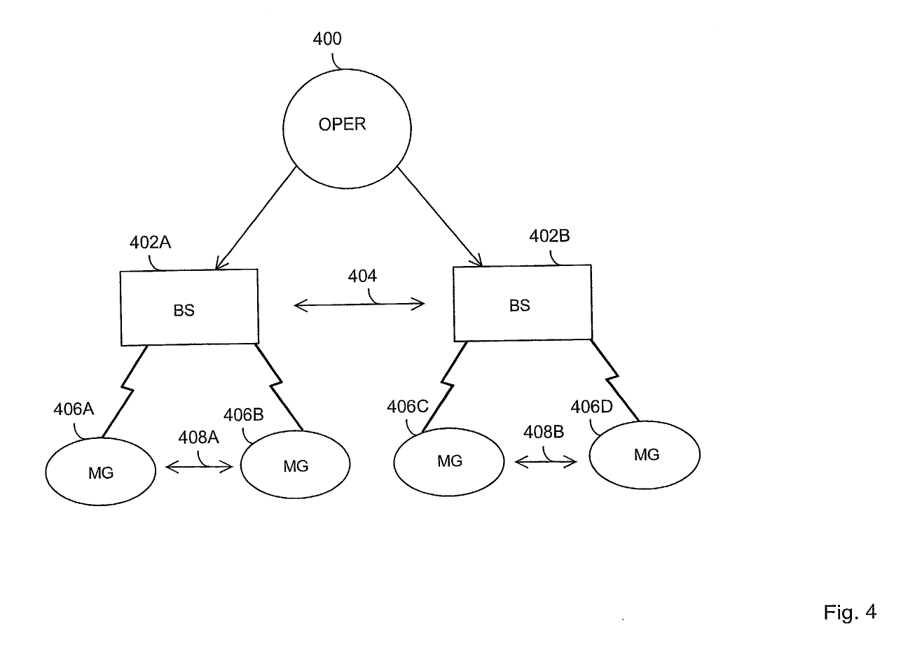

FIG. 4 shows how the channels are used, for example, in a single operator network. A hierarchy element 400 on top illustrates the channel space used by the operator. The channel space of the operator is divided into base stations by means of network planning. When using fixed channel allocation FCA, each base stations is provided with particular channels taking the reuse into account. Thus, for instance, two adjacent base stations may use the same channel, but the sectoring of base stations tend to reduce the interference the users operating on the channels cause one another. Here, sectoring refers to the base stations sending the same channel into different directions. A second level 402A and 402B of the hierarchy shows the channel sets allocated to the base stations. The channel sets available to the base stations may be fixed or the channels may vary dynamically between the base stations, as illustrated by line 404. The dynamic channel allocation between base stations can be employed for example in significant loading and interference situations. The lowest level in the hierarchy shown in FIG. 4 illustrates the terminal groups formed of the terminals within the coverage area of the base stations. The terminals in the base station 402A area form two terminal groups 406A and 406B, and the terminals in the base station 402B area form two terminal groups 406C and 406D. The channel set of the terminal group 404A refers to channels, which are placed on the priority and candidate lists of the terminal group. The base station channels 402A can also be fixedly and dynamically allocated between the terminal groups 404A to 404B. Lines 408A and 408B show how the channels can be transferred dynamically between the terminal groups 404A and 404B within the influence area of the base station. In practice, the fact that the channels between the base stations can be dynamically transferred in accordance with the connection 404 indirectly also indicates that the channels are able to be transferred dynamically between the terminal groups of the different base stations, for example between terminal groups 404B and 404C.

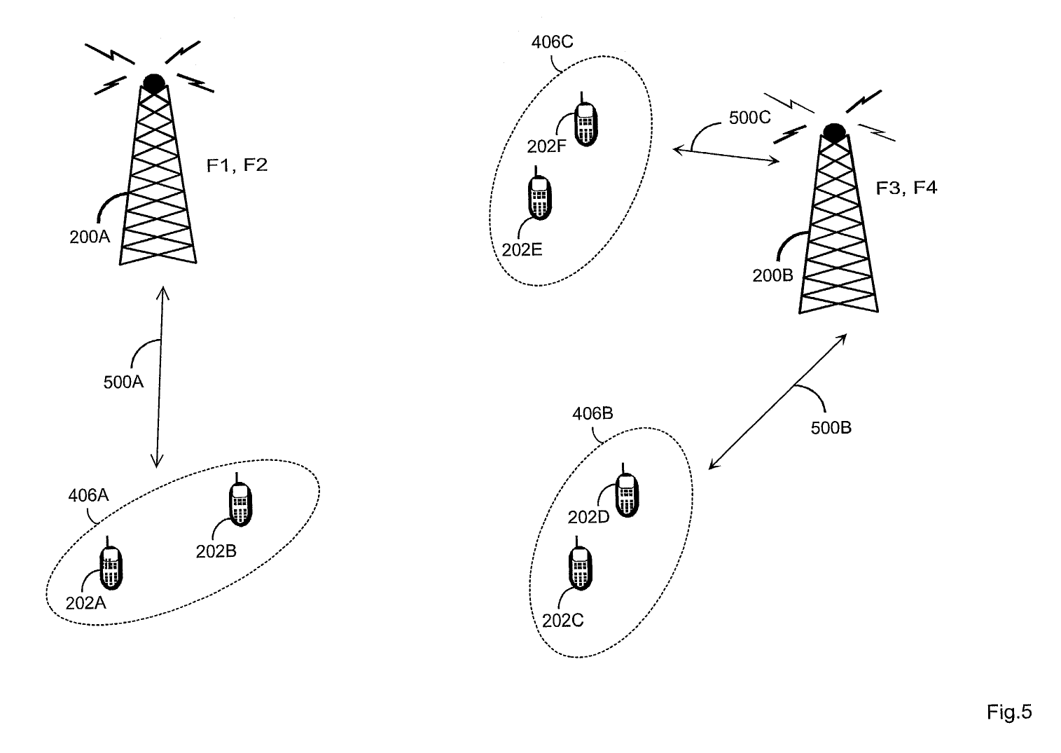

FIG. 5 shows how the terminals are grouped based on the location thereof. The Figure illustrates two base stations 200A and 200B. The base station 200A serves two terminals 202A to 202B, which are located substantially within the same area at a distance 500A, thus forming the terminal group 406A. The base station 200A has in the example shown in Figure two frequencies F1 and F2 in use, when the TDMA system is concerned. The base station 200B serves four terminals 202C to 202F, whereof 202C to 202D are located substantially within the same area at a distance 500B, thus forming the terminal group 406B. The terminals 202E to 202F are placed at a distance 500C, thus forming the terminal group 406C. The base station 200B may use two frequencies F3 and F4 in the example shown in FIG. 4, when the TDMA system is concerned. Two frequencies are allocated for both base stations 202A and 202B, even though the base station 202B serves several users. In a cellular radio network, for example in a base station controller, the radio channels may be allocated in advance to the terminal groups so that certain terminal groups have more capacity in the downlink direction than other terminal groups. For example in FIG. 5, the terminal group 406C might include several channels in the downlink direction. In such a case, the terminal 202E arriving at close range to the base station 200B and requiring a lot of capacity in the downlink direction could be placed in the group 406C. Consequently, the problem concerning a terminal group comprising terminals that simultaneously communicate in both uplink and downlink directions can be reduced. In such a situation the terminal communicating in the uplink direction can for example increase the transmission power, and thus complicate the reception of the terminal receiving in the downlink direction. In another embodiment, preplanning between uplink and downlink channels is not carried out between the base stations. However, then the channels having problems caused by asymmetry, obtain poor measurement results during the measurements carried out during use and idle time slots, and are therefore not easily allocated for use. In a preferred embodiment, when a new terminal enters the group, for example 202B arrives substantially into the area of group 406A, the cellular radio network determines the location of the terminal. The location can be determined for example on the basis of a burst sent on a random access channel RACH. The burst is analyzed in three different base stations and a triangulation method is employed for determining the position of the terminal. The terminals report in turn the serving base stations about the control signal strengths received from all surrounding base stations. In order to maintain the measurement reports required for maintaining the priority and candidate lists, the terminal signals in a preferred embodiment with a cellular radio network control channel.

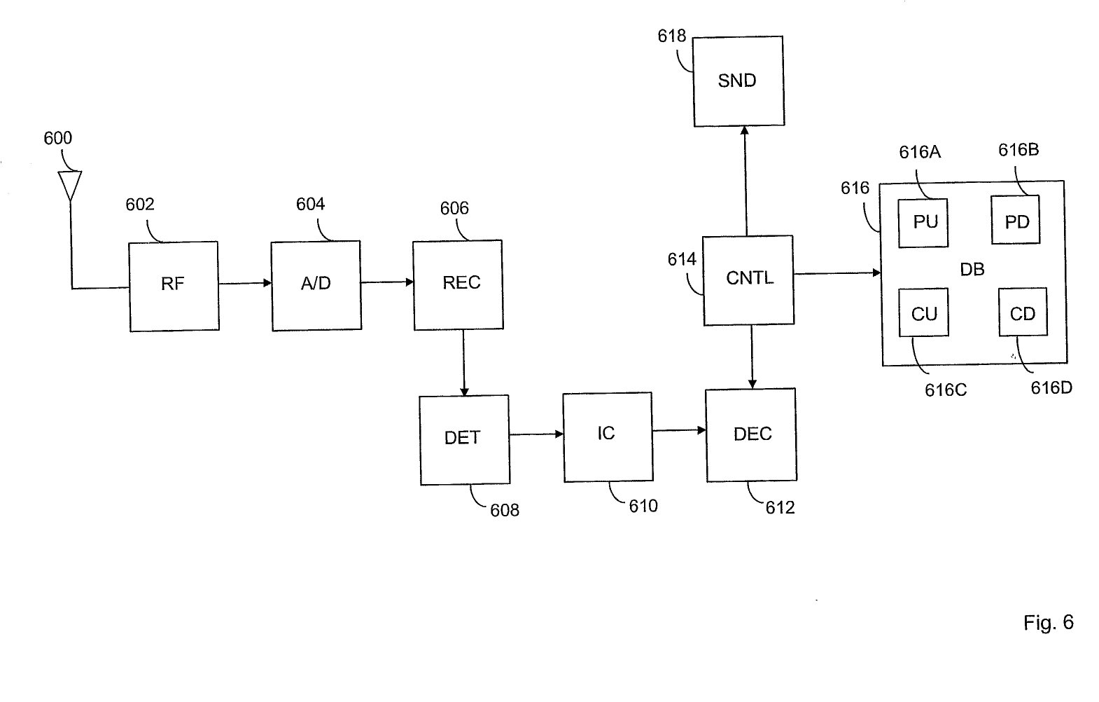

FIG. 6 describes a preferred embodiment of a receiver of the invention. The receiver comprises one or more antennas 600 for receiving a broadband combination signal. After the radio frequency parts 602 the signal is directed to an analogue-digital converter 602, in which the analogue signal is converted into digital mode and sampled. Each user's multipath-propagated components and the delay thereof are searched for from the broadband signal in a receiver unit 604. A Matched Filter (MF) is, for instance, used for retrieving the signal components. The signal power can be determined at different delays by sliding said filter in relation to the received signal. In a preferred embodiment the receiver is a CDMA receiver of RAKE type, in which the best components with different delays are directed to different RAKE branches for receiving user signals. One RAKE branch includes for example a detection stage 608, in which the received combination signal is correlated with the user despreading code, when the user signal can be distinguished from the combination signal. In the detection stage 608 the initial symbol estimates are formed from the user signal. The symbol estimates are improved in one or more interference cancellation stages 610, and as an output thereof the final symbol estimates of the symbols sent by the user are obtained. The symbols thus detected are applied to decoding 612, where the interleaving and channel coding performed for the user signals are released. The channel coding release results in obtaining information concerning the received signal about the quality of the radio channel used, for example. The decoding routine 612 provides a connection to a controller 614 of the invention, to which the method steps of the invention in a preferred embodiment presented in FIGS. 3 to 5 are implemented. The method steps are implemented to the controller 614 preferably as software for a general-purpose processor, but can also be implemented as an ASIC (Application Specific Integrated Circuit) or by a separate logic component. The controller 614 also communicates with a database 616, in which the priority and candidate lists are stored for example as indexed tables. The tables can be formed for example so as to provide each user group with a specific uplink priority list 616A, a specific downlink priority list 616B, a specific uplink candidate list 616C and a specific downlink candidate list 616D. Obviously, for example the uplink candidate lists of all user groups can also be implemented in a single uplink candidate list 616C. The controller also communicates with a transmitter unit 618, through which the channels on the channel lists are allocated to the users. The transmitter unit comprises substantially corresponding apparatus parts as the presented receiver parts 600 to 612, but the description thereof is not essential in this context. It is obvious that the receiver comprises other apparatus parts in addition to the ones described in FIG. 6 but the description thereof is not relevant regarding the invention.

Even though the invention has above been explained with reference to the example in the accompanying drawings, it is obvious that the invention is not restricted thereto but can be modified in various ways within the scope of the inventive idea disclosed in the attached claims.

What is claimed is:

1. A method for carrying out dynamic channel allocation in a cellular radio network, comprising:
grouping the terminals communicating over a radio connection with the base station of the cellular radio network into one or more terminal groups on the basis of the location of the terminals;
forming a priority list for each terminal group of the radio channels in the cellular radio network from the highest quality channels as regards the terminal group, and
allocating one or more radio channels from the channels on the priority list to the terminal if need be.

2. A method as claimed in claim 1, wherein grouping the terminals into terminal groups is done on the basis of the distance between the terminals and the base station.

3. A method as claimed in claim 1, wherein forming the priority list for each terminal group in the uplink and downlink direction.

4. A method as claimed in claim 1, further comprising:
forming a candidate list for each terminal group for maintaining one or more candidate radio channels.

5. A method as claimed in claim 4, wherein forming a candidate list for each terminal group in the uplink and downlink direction.

6. A method as claimed in claim 4, wherein arranging the radio channels maintained on the uplink candidate list on the basis of the reception power into an order of intensity, the reception power being measured in the base station of the cellular radio network.

7. A method as claimed in claim 4, wherein arranging the radio channels maintained on the uplink candidate list on the basis of the reception power into an order of intensity, the reception power being measured in one or more terminals.

8. A method as claimed in claim 1, wherein maintaining the priority list of the terminal group in the base station of the cellular radio network.

9. A method as claimed in claim 4, wherein maintaining the candidate list of the terminal group in the base station of the cellular radio network.

10. A method as claimed in claim 4, wherein replacing the radio channel to be removed from the priority list with the best channel on the candidate list.

11. A method as claimed in claims 4, wherein moving one or more radio channels from the candidate list to the priority list in order to increase the number of available radio channels.

12. A method as claimed in claim 1, wherein storing one or more radio channels of the highest quality on the priority list based on the measurement report obtained regarding the use of the radio channel.

13. A method as claimed in claim 12, wherein forming the measurement report of the uplink radio channel in the base station.

14. A method as claimed in claim 12, wherein forming the measurement report of the downlink radio channel in the terminal.

15. A method as claimed in claim 12, wherein forming a measurement report based on the negative acknowledgements (NACK) of the packets to be sent on the radio channel.

16. A method as claimed in claim 12, wherein forming a measurement report based on the signal-to-interference ratio (SIR) of the radio channel.

17. A method as claimed in claim 12, wherein forming a measurement report based on the cyclic redundancy check (CRC).

18. A method as claimed in claim 12, wherein forming an evaluation on the basis of the measurement report whether the radio channel employed is good or poor and calculating on said basis a priority value for the channel using the formula
$${P}_{i + 1} = \frac{i i}{{N}_{i} + 1} ,$$
where P depicts the channel priority value and N the number of measurement reports and I the consecutive number of the priority value and the measurement report.

19. A method as claimed in claim 12, wherein setting a threshold value for the priority value and removing the channel from the priority list whose priority value decreases below the threshold value.

20. A cellular radio system comprising at least one base station and at least one terminal communicating over a radio connection with the base station, and a controller for carrying out dynamic channel allocation in a cellular radio network, wherein the controller included in the cellular radio system is arranged
to group said one or more terminals communicating over a radio connection with the base station of the cellular radio system into one or more terminal groups based on the location of the terminals;
to form a priority list for each terminal group of the radio channels in the cellular radio network from the highest quality channels as regards the terminal group, and
to allocate one or more radio channels from the channels on priority list to the terminal if need be.

21. A cellular radio system as claimed in claim 20, wherein the controller is arranged to group the terminals into terminal groups based on the distance between the terminals and the base station.

22. A cellular radio system as claimed in claim 20, wherein the controller is arranged to form a priority list for each terminal group in the uplink and downlink directions.

23. A cellular radio system as claimed in claim 20, wherein the controller is arranged to form a candidate list for each terminal group for maintaining one or more candidate radio channels.

24. A cellular radio system as claimed in claim 23, wherein the controller is arranged to form a candidate list for each terminal group in the uplink and downlink directions.

25. A cellular radio system as claimed in claim 23, wherein the controller is arranged to arrange the radio channels maintained on the uplink candidate list on the basis of the reception power into an order of intensity, and the reception power is measured in the base station of the cellular radio network.

26. A cellular radio system as claimed in claim 23, wherein the controller is arranged to arrange the radio channels maintained on the downlink candidate list on the basis of the reception power into an order of intensity, and the reception power is measured in one or more terminals.

27. A cellular radio system as claimed in claim 23, wherein the base station is arranged to maintain the priority list of the terminal group.

28. A cellular radio system as claimed in claim 23, wherein the base station is arranged to maintain the candidate list of the terminal group.

29. A cellular radio system as claimed in claim 23, wherein the controller is arranged to replace the radio channel removed from the priority list with the best channel on the candidate list.

30. A cellular radio system as claimed in claim 23, wherein the controller is arranged to move one or more radio channels from the candidate list to the priority list in order to increase the number of available radio channels.

31. A cellular radio system as claimed in claim 20, wherein the controller is arranged to maintain one or more radio channels of the highest quality on the priority list on the basis of the measurement report obtained regarding the use of the radio channel.

32. A cellular radio system as claimed in claim 31, wherein the base station is arranged to form the measurement report of the uplink radio channel.

33. A cellular radio system as claimed in claim 31, wherein the terminal is arranged to form the measurement report of the downlink radio channel.

34. A cellular radio system as claimed in claim 31, wherein the base station is arranged to form the measurement report based on the negative acknowledgements (NACK) of the packets to be sent on the radio channel.

35. A cellular radio system as claimed in claim 31, wherein the base station is arranged to form the measurement report based on the signal-to-interference ratio (SIR) of the radio channel.

36. A cellular radio system as claimed in claim 31, wherein the base station is arranged to form the measurement report based on the cyclic redundancy check (CRC).

37. A cellular radio system as claimed in claim 31, wherein the controller is arranged to form an evaluation on the basis of the measurement report whether the radio channel employed is good or poor and to calculate on said basis a priority value for the channel using the formula
$${P}_{i + 1} = \frac{i i}{{N}_{i} + 1} ,$$
where P depicts the channel priority value and N the number of measurement reports and i the consecutive number of the priority value and the measurement report.

38. A cellular radio system as claimed in claim 37, wherein the controller is arranged to set a threshold value for the priority value and to remove the channel from the priority list whose priority value decreases below the threshold value.
